(19) United States
(12) Patent Application Publication
(10) Pub. No.: US 2007/0277441 A1
(43) Pub. Date: Dec. 6, 2007

(54) Vehicle Window Regulator Having a Floating Window Carrier

(76) Inventors: Peter J. Smith, Newmarket (CA); Dan R. Gidden, Bradford (CA); Noel Chingcuanco, North York (CA)

Correspondence Address: CLARK HILL, P.C., 500 WOODWARD AVENUE, SUITE 3500, DETROIT, MI, 48226, US

(21) Appl. No.: 10/580,928

(22) PCT Filed: Dec. 3, 2004
(86) PCT No.: PCT/CA04/02075

§ 371 Date: Feb. 21, 2007

Related U.S. Application Data
(60) Provisional application No. 60/527,312, filed on Dec. 5, 2003.

(51) Int. Cl. E05F 11/38

(52) U.S. Cl. 49/211

(57) ABSTRACT

A window regulator including a drive rod having a linear axis; a runner connected to the drive rod for movement therealong; a window carrier pivotally secured to the runner for supporting a window; and a guide engaged by the window carrier having a radius of curvature such that the window carrier moves the window along a path coincident with the radius of curvature as the runner moves linearly along the drive rod.

### FIELD OF THE INVENTION

This invention relates to a window regulator, as used in a vehicle door.

### BACKGROUND OF THE INVENTION

A window regulator is a mechanism under which control a vehicle window, e.g. a passenger door window is raised and lowered. Various types of window regulators are known.

In modern vehicles, auto windows are generally curved, having a major outwardly convex surface. A side door window, for example, thus has a forward upright edge and a rearward upright edge, each located in an arcuate guide rail which defines a travel path followed by the window as it moves between upper and lower positions. It is in this context that advantages of the invention described herein would be most apparent.

### SUMMARY OF THE INVENTION

According to one aspect of the invention a window regulator is provided which includes a linear element, such as a frame or rod, that defines a first axis. A runner is mounted to translate linearly along the linear element. A window carrier is pivotally and slidably connected to the runner so as to translate along a second axis substantially orthogonal to the first axis and rotate about a third axis substantially orthogonal to both the first and second axes. This device enables an arcuate window to be mounted to the window carrier. The window is slidably mounted in at least one glass run channel having a curvature substantially identical to the curvature of the window. When the runner is translated along the linear element using any suitable means, the runner follows a linear path but the window and window carrier will follow an arcuate path dictated by the glass run channels.

According to another aspect of the invention, a window regulator is provided having a runner that travels along a guide rod. A carrier is connected to the window, and the runner engages the carrier to force the window up and down as the runner travels along the guide rod. The engagement of the runner and carrier provides for movement of carrier along the travel path of the window without necessarily precisely following the travel path of the runner.

The upright edges of such a window are engaged by guide rails within the vehicle door, the guide rails being generally arcuate to match the arcuate shape of the window, and to define the travel path of the window as it moves up or down. The carrier, e.g. support plate, affixed at the bottom of the window must follow the arcuate travel path of the window. The runner, which is forced by a generally conventional means to move up and down along the guide rod engages the carrier. Because the invention permits the window carrier to move with respect to the rod in a direction that is not precisely parallel to the travel path of the runner, the rod is not required to be in the shape of the travel path of the window, that is, the rod is not required to have the arcuate shape of the rail guides.

Automotive doors come in a variety of shapes and sizes, and so too do their windows. Windows thus have differing degrees of curvature, which of course determines the different travel path each must follow when being raised and lowered. Because the travel path of the runner, i.e., the shape of the guide rod is not required to match the curvature of the window guide rails, a lift mechanism of the present invention (outside of the guide rails) can be used with windows of differing degrees of curvature.

In one of the embodiments described below, one or the other of the runner and the carrier preferably includes a pair of channels generally traverse to a major window surface (i.e., generally orthogonal to the travel of the runner) and the other of the runner and the carrier includes a pair of trunnions. Each trunnion is received in one each of the channels and each trunnion includes a surface which is shaped to engage a surface of the channel into which it is received to permit, as the runner travels in an axial direction along the rod, movement of the carrier along the arcuate travel path of the window.

Other means for slidingly and pivotally connecting the carrier to the runner are described in greater detail below.

### BRIEF DESCRIPTION OF THE DRAWINGS

A detailed description of the invention, including the best mode of the invention currently known or contemplated by the inventor is set out below, reference being made to the attached drawings in which:

FIG. 1 illustrates generally a vehicle side door having a window regulator assembly according to the invention installed therein;

FIG. 2 is an isometric view showing the components of a drive mechanism according to a first embodiment of the invention;

FIG. 3 is a view similar to that of FIG. 2, showing a carrier plate for the window installed;

FIG. 4 is an isometric view showing the inner and lowers sides of the carrier plate shown in FIG. 3 in relation to certain drive components;

FIG. 5 is an isometric view showing the outer and upper sides of the carrier plate shown in FIG. 3;

FIGS. 6A-6C are cross-sectional views of the first embodiment showing the position of a runner in a channel of the window carrier plate as the window is moved from a lower, open position (FIG. 6A) to an upper, closed position (FIG. 6C);

FIG. 7 is an exploded view of an alternative runner and slider combination;

FIGS. 8A and 8B are isometric views showing the components of a drive mechanism according to a second embodiment of the invention;

FIGS. 9A and 9B are detailed views of regions IX-A and IX-B of FIGS. 8A and 8B, respectively;

FIG. 10 is a detailed elevation view of the second embodiment;

FIG. 11 is a view similar to that of FIG. 10, showing a variant window carrier plate and variant connection between the carrier plate and runner;

FIGS. 12A and 12B are detail elevation views showing another variant of second embodiment, having a runner modified for convenience of installation of a window and carrier plate; and

FIGS. 13A and 13B are isometric views showing a third embodiment, in which an arm, pivotally mounted to a runner, supports the carrier plate.

### DETAILED DESCRIPTION OF PREFERRED EMBODIMENTS

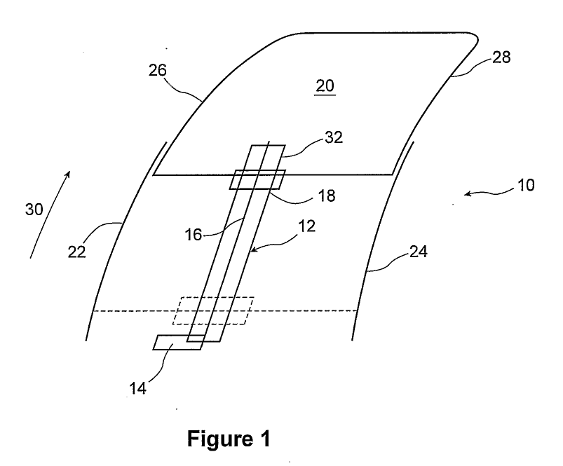

Turning to the drawings, a window regulator assembly 12 is schematically illustrated in FIG. 1. The assembly 12 is installed as part of vehicle side passenger door 10 and includes a linear lead screw or threaded drive rod 16, rotatably mounted on a frame 32. A carrier plate 18 is slidingly mounted to the frame and also slidingly and pivotally mounted to the drive rod, as described in greater detail below. An arcuate window 20 is mounted to the carrier plate 18 at the lower edge of the window. The assembly 12 includes arcuate forward and rearward glass run channels 22, 24 which receive, respectively, the forward upright edge 26 and rearward upright edge 28 of the window 20. As described in greater detail below, rotation of the drive rod 16 leads to axial and pivotal movement of the carrier plate 18 therealong corresponding to the arcuate travel path of the window 20 as it rides upwards and downwards in the arcuate glass run channels 22, 24.

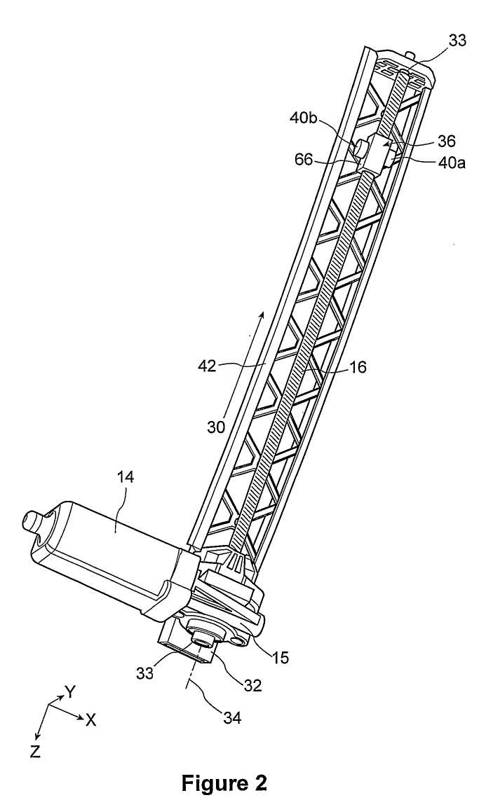

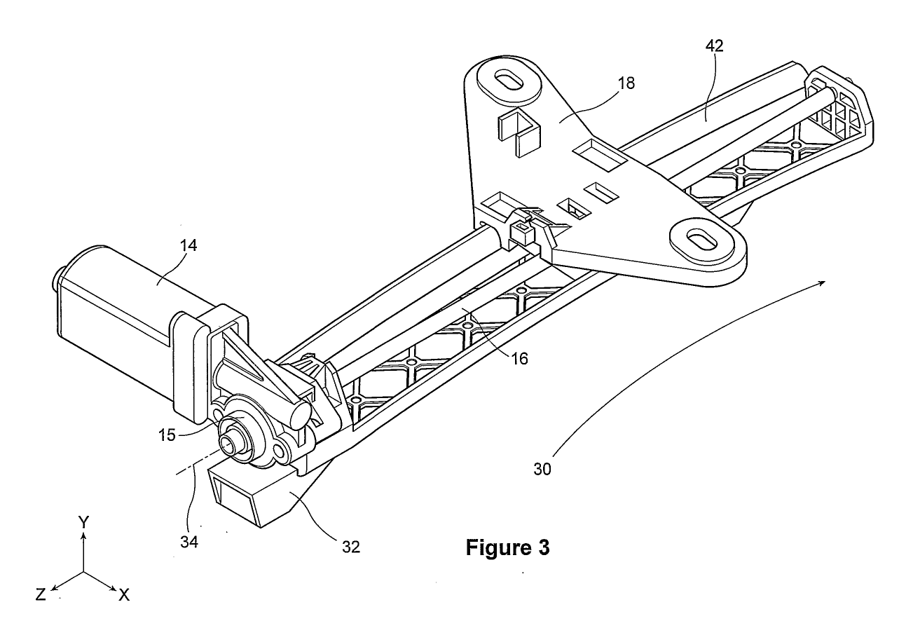

FIG. 2 is an isolated view of the drive components of window regulator assembly 12 according to a first embodiment. The assembly 12 includes a longitudinal base frame 32 secured within the interior of the door at both ends thereof. The drive rod 16 is journaled for stationary rotation in the frame 32 via bushings 33. The actuator, such as electric motor 14 coupled to a gear reducer 15, is drivingly connected to the lower end of drive rod 16 by any suitable manner known in the art, such as through the use of gears, a belt drive, a flexible cable or a universal joint, in order to rotate the drive rod about its central linear axis 34. A runner 36 having an internal threaded bore 38 is threadingly mounted on the drive rod. As will be explained further below, in the fully assembled mechanism, runner 36 is prevented from rotating with respect to the drive rod, and thus the runner travels axially along the drive rod when it rotates, either up or down, depending upon the direction of the rotation. The travel path of the runner thus parallels the central linear rotational axis 34 of drive rod 16, and thus the drive rod essentially acts as a guide rod for the runner. Runner 36 includes trunnions 40a, 40b which have an elliptical cross section, the purpose of which will be described in greater detail below. Base frame 32 includes an integrally formed guide 42 having the same arcuate bend as window channel runs 22, 24, the function of guide 42 being described further below.

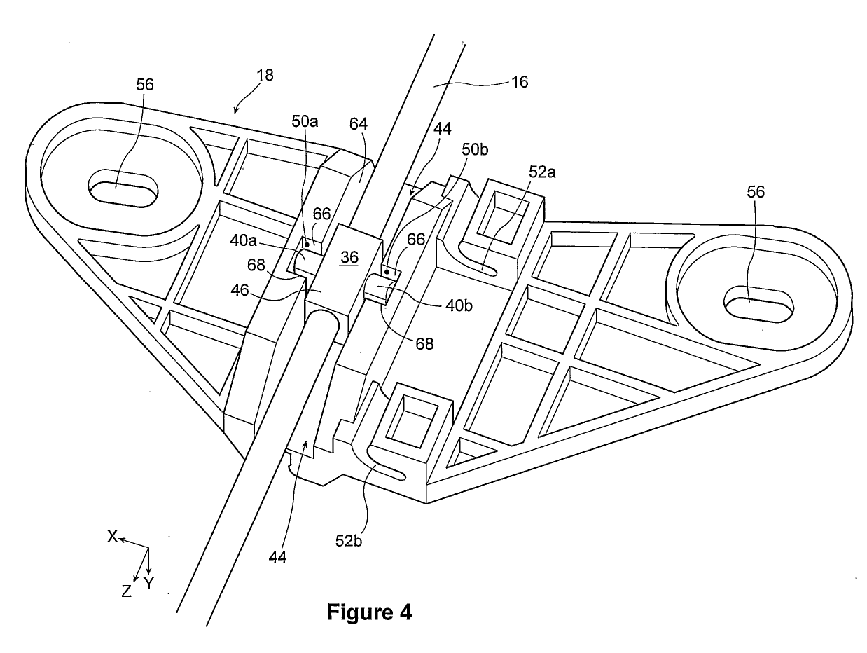

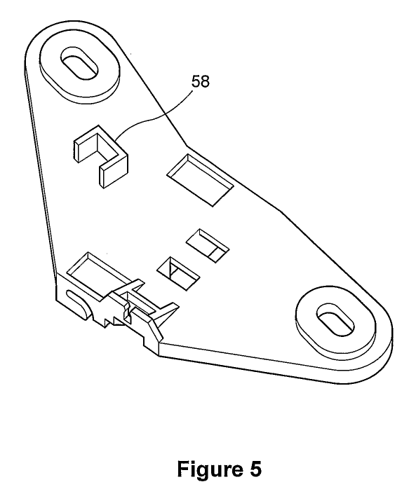

FIG. 3 is similar to FIG. 2, but shows carrier plate 18 installed on frame 32. Referring additionally to the isolated view of FIG. 5, carrier plate 18 includes a primary channel 44, which is generally axially upright when installed. The channel 44 receives the longitudinal body portion 46 of runner 36. The trunnions 40a, 40b, which protrude from the longitudinal body portion 46 of runner 36, seat in secondary channels 50a, 50b, respectively, cut into sidewalls 64 carrier plate 18. Carrier plate 18 also defines slider channels 52a, 52b, which receive guide 42 of frame 32.

Plate 18 is rigidly affixed to window 20 by means of fasteners (not shown) received through plate apertures 56 that communicate with suitably located apertures in the window. Further support is leant to the plate-window connection by protruding plate support 58 (FIG. 5) on which the lower edge of the window rests. Many other techniques for attaching glass to the carrier plate are well known in the art and may be used in the alternative.

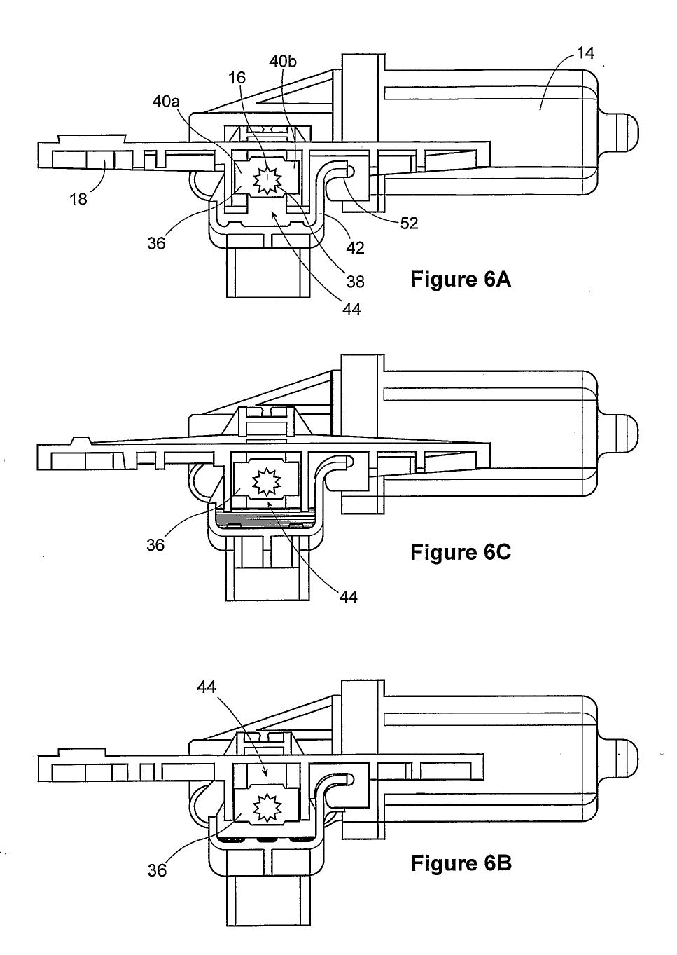

The upward and downward motion of runner 36 is caused by rotation of drive rod 16 under control of the actuator. The runner 36 is prevented from rotating with respect to drive rod 16 because longitudinal body portion 46 of runner 36 is ensconced in the primary channel 44 of carrier plate 18, abutting the side walls 64 thereof. More particularly, the cross-sectional shapes of the surfaces defining the primary channel and the longitudinal portion of the runner match each other sufficiently to affix the runner against rotation about the axis of the drive while at the same time permitting the required degree of movement of the runner in other directions within the channel, described further below. Central axis 34 of drive rod 16 is linear so the travel path of runner 36 as it travels between the upper and lower positions shown in FIG. 1 is also linear. Window 20 and plate 18 follow parallel arcuate travel paths as defined by rails 22, 24 and guide 42, an arcuate axis of each of these being parallel to the arc indicated by arrow 30. The arcuate path followed by the plate, the upward and downward motion of which is driven by the runner, which itself follows a linear path, is accommodated by elliptical surfaces 60 of the trunnions which bear on surfaces 66, 68 of the secondary channels of the plate. In other words, the elliptical cross-section of the trunnion surfaces which bear on surfaces of the secondary channels of the carrier plate permit the plate to pivot slightly and to move towards or away from drive rod 16 (in a cross-car direction) as necessary to accommodate the non-parallel travel paths of the plate and runner. This is shown in the cross-sectional views of FIGS. 6A-6C which illustrate the position of the runner 36 within the channel 44 as the window moves from a lower, open position (FIG. 6A) to an upper, closed position (FIG. 6C). It will further be appreciated that guidance of the plate along the travel path of the window (as determined by guide rails 22, 24) is further assured by the fit of guide 42 on base 32 within slider channels 52a, 52b, which precludes undue stress from being placed on the window. In preferred embodiments, the window and glass run channels will also have a uniform radius of curvature which is imparted to the slider channels.

A variant of the first embodiment is shown in FIG. 7 in which trunnions 66a, 66b of runner 68 are received within gliders 70a, 70b having apertures 72a, 72b. The gliders, in turn, are mounted in the secondary channels of the carrier plate.

It will be noted from the foregoing the arcuate guide 42 enables the length of the glass run channels 22, 24 to be minimized. That is, the glass run channels do not have to be the full height of the window travel since the guide/frame can support the window and its arcuate travel.

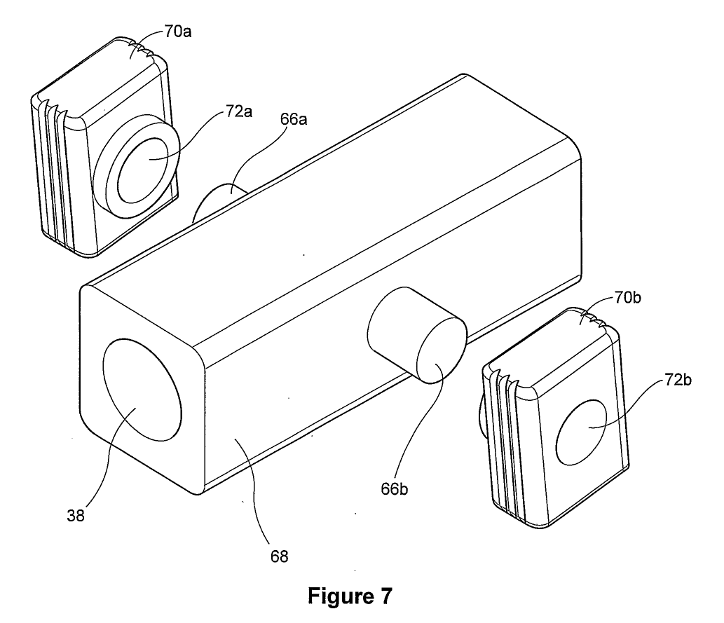

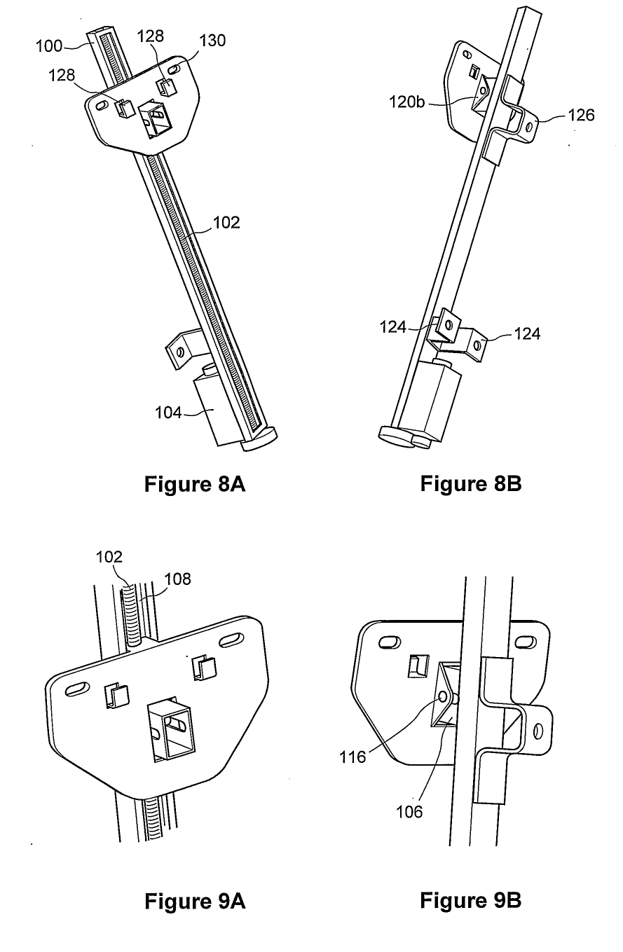

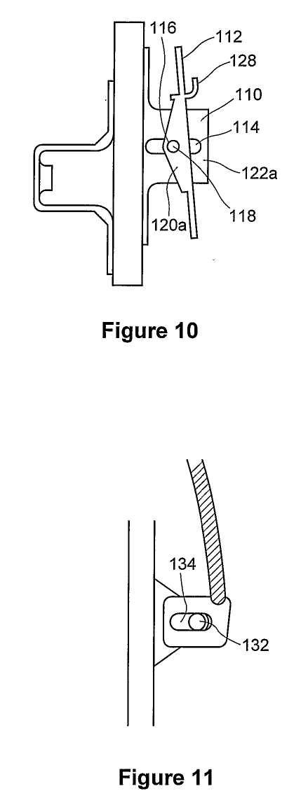

FIGS. 8A, 8B, 9A, 9B & 10 illustrate a second embodiment of the invention. Here, channel frame 100 has an upright threaded drive rod 102 rotatably mounted thereto. The top end is thus suitably journaled to the frame, with the lower end drivingly connected to motor 104. A runner 106 is seated within channel 108 of frame 100, the channel 108 being of relative constant cross section along the travel path of the runner, with the outer cross section of the runner generally matching the cross section of the channel. The runner is again rotatably mounted on the drive rod, the matching surfaces of the runner and the channel into which it is received precluding rotation of the runner within the channel so that rotation of the drive rod results in the travel of the runner.

The runner 106 has an arm 110 protruding from the channel frame 100 and a carrier plate 112 is mounted to the arm 110. More particularly, arm 110 includes a slot 114, which lies in a plane generally orthogonal to the axis of screw 102. A carrier mounting shaft, bolt 116, is received within slot 114. Bolt 116 provides an axis of rotation 118 for the carrier plate, which axis is parallel to the plane of the slot and orthogonal to the rotational axis of drive rod 102. Mounting bolt 116 is also free to move parallel to the plane of slot 114, towards and away from screw 102, which corresponds to the cross-car direction in the case of the mechanism being installed in a passenger door of an automobile. Carrier plate 112 includes abutment walls 120a, 120b, which walls abut side walls 122a, 122b of runner arm 110 to substantially limit translational movement of the plate to movement towards and away from the lead screw, i.e., to preclude movement of the axis of rotation of the carrier plate to being within the plane of the slot.

Channel frame 100 includes mounting members 124, 126 for affixing the window drive mechanism to the automobile, as within the interior of a car door. Again, the rotation of the carrier plate about axis 118, and translation of the plate in a direction parallel to the plane of slot 114, provides for the arcuate movement required of the plate as it moves up and down along the rotating drive rod, despite the fact that the frame and the drive rod are linear in configuration.

In a variant of the second embodiment, shown in FIG. 11, runner trunnions 132 are received within carrier plate slots 134, only one of each being illustrated in FIG. 11.

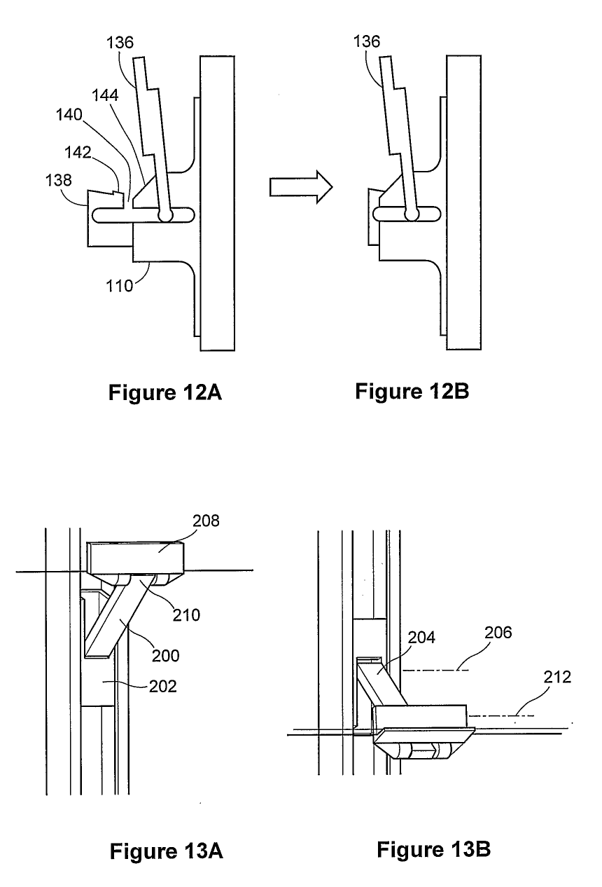

For ease of installation, runner arm 110 may include an opening into which is slidingly received separate slotted member 138. When in the open position as illustrated in FIG. 12A, in which member 138 is drawn away from the base portion of the runner arm, gap 140 is provided between the overhanging portions 142, 144 of the slotted member and the base of the arm, respectively. When the slotted member is in this position, bolt 116 of the carrier plate can be received into the slot, the slotted member slid into the closed position of FIG. 12B for installation of the carrier plate and window. Suitable securing means is provided to hold the slotted member in the installed position to the runner arm.

In the case of the second embodiment, as illustrated, the travel path of the carrier plate is not fixed with respect to the channel frame (as for example, by guide 42 and slider channels 52a, 52b of the first embodiment). The travel path is thus defined by only by glass run channels 22, 24 suitably mounted to the automobile. See FIG. 1. One of the advantages of this embodiment is that the window travel is not dictated by the curvature of the window regulator rail which, as a result of manufacturing tolerances, may differ from the curvature of the glass run channels. This enables the system to be used in a wide variety of vehicle doors since the rail does not have to be specifically manufactured for various vehicle models. In order to further augment this capability, the carrier plate can be configured to receive a bracket to which the window pane is bonded with a suitable adhesive.

A third embodiment of the invention is illustrated in FIGS. 13A and 13B. Here, arm 200 is pivotally connected to runner 202 at first end 204 having first axis of rotation 206. Carrier plate 208 is connected to the arm at second end 210. Each pivotal connection provides for rotation about an axis that lies in a plane orthogonal to the axis of rotation of the lead screw, and which is also orthogonal to the axis of the drive rod. The two axes of rotation 206, 212 are thus generally parallel to each other. Again, this arrangement permits movement of the carrier plate with respect to the arm and movement of the arm with respect to the runner, as the runner moves along the drive rod provides for the movement required of the plate as it moves up and down along the rotating drive rod.

It will be appreciated that a motor of the mechanism can be conveniently mounted through appropriate helical or bevel gears, belt drive, etc. to rotatingly drive the drive rod. Rotation in first angular direction (e.g. clockwise) leads to lifting of the carrier plate and window, and rotation of the drive in a second direction, opposite to the first (e.g., counterclockwise) leads to a lowering of the window. Alternative drive mechanisms to a rotating lead screw or drive can be used. For example, in the second embodiment, the raising and lowering of the runner along the rod guide can be achieved through the use of a cable and drum mechanism, synchronous cable, etc.

The illustrated embodiments have been described with particularity for the purposes of description. Those skilled in the art will appreciate that a variety of modifications may be made to the embodiment described herein without departing from the spirit of the invention.

1. An automotive window regulator system comprising:
a guide rod having a linear axis;
a runner connected to the rod for movement therealong between a first position and a second position; and
a window carrier engaged by the runner for movement thereby;
wherein the runner and carrier are rotatably connected to each other about a rotational axis orthogonal to the axis of the rod and translatable with respect to the central axis as the runner moves between the first and second positions, to permit nonparallel movement of the carrier with respect to the rod as the runner moves between the first and second positions.

2. A system according to claim 1, including an arcuate window mounted to said carrier, and further comprising first and second glass run channels, each having the same radius of curvature of the window, into which first and second edges of the window are received, the glass run channels defining the path of travel of the window as the runner moves between the first and second positions.

3. A system according to claim 1, including an arcuate window mounted to said carrier, and further comprising a guide which engages the carrier, the guide having a radius of curvature concentric with the radius of curvature of the window such that the carrier guides the window along a path coincident with the radius of curvature of the window as the runner moves between the first and second positions.

4. A system according to claim 1, wherein one or the other of the runner and carrier defines a channel and the other of the runner and carrier comprises a shaft received in the channel, the shaft being rotatable about said rotational axis, and translatable within the channel to obtain said non-parallel movement of the carrier.

5. A system according to claim 1, wherein the shaft is provided by a trunnion.

6. A system according to claim 1, wherein the runner and carrier are connected by an arm pivotally connected to each of the runner and carrier.

7. A system according to any of the preceding claims, wherein the guide rod is a straight threaded screw and the runner includes a threaded bore threadingly received onto the rod.

8. A system according to claim 7, further comprising a motor which rotationally drives the rod about its central axis to move the runner between the first and second positions.

9. An automotive window regulator, comprising:
an upright guide rod having a central linear axis;
a runner connected to the rod for movement therealong between a lower position and an upper position;
a window carrier engaged by the runner for movement thereby along the axis of the rod; and
an arcuate window, having a radius of curvature, affixed to the carrier; and wherein,
the runner and the carrier are rotatably connected to each other about a rotational axis orthogonal to the axis of the rod and the carrier is radially movable with respect to the central axis of the rod as the runner moves between the lower and upper positions to permit movement of the window along an arcuate path having a radius of curvature equal to that of the window.

10. A window regulator, comprising:
a linear element, defining a first axis;
a runner translatable along the linear element; and
a window carrier pivotally and slidably connected to the runner so as to translate along a second axis substantially orthogonal to the first axis and rotate about a third axis substantially orthogonal to both the first and second axes.

11. A window regulator according to claim 10, including:
an arcuate window mounted to the window carrier; and
at least one arcuate glass run channel having a curvature substantially identical to the curvature of the window, the window being slidably mounted in the at least one glass run channel.

12. A window regulator according to claim 11, including means for translating the runner along the linear element, whereby the runner follows a linear path and the window and window carrier follow an arcuate path dictated by the glass run channels.

13. A window regulator according to claim 12, wherein:
the linear element is a threaded drive rod;
the runner includes a threaded bore mounted on the drive rod; and
the runner translation means includes means for rotating the drive rod and preventing the rotation of the runner relative to the drive rod.

14. A window regulator according to claim 13, wherein the runner rotation prevention means includes a channel formed in one of the carrier and the runner extending substantially parallel to the first axis, the other of the pair having a longitudinal body mounted in the channel.

15. A window regulator according to claim 12, including a frame having an arcuate guide substantially matching the curvature of the window, and wherein the window carrier is slidably mounted to the arcuate guide.

16. A window regulator according to claim 12, wherein one of the runner and the carrier includes at least one channel extending substantially parallel to the second axis and the other of the pair includes at least one trunnion disposed in the channel.

17. A window regulator according to claim 12, wherein the linear element is a frame having a substantially linear channel therein defining the first axis, the runner being mounted in the channel.

18. A window regulator according to claim 17, wherein the runner has a slot therein defining the second axis, and a shank pivotally mounts the window carrier to the runner via the slot.
